(19) United States
(12) Patent Application Publication
(10) Pub. No.: US 2007/0262968 A1
(43) Pub. Date: Nov. 15, 2007

(54) INPUT DEVICE

(75) Inventors: Kazuhito Ohshita, Fukushima-ken (JP); Yasuji Hagiwara, Fukushima-ken (JP); Tadamitsu Sato, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/746,479

(22) Filed: May 9, 2007

(30) Foreign Application Priority Data
May 10, 2006 (JP) 2006-131155

(51) Int. Cl. G06F 3/041

(52) U.S. Cl. 345/173

(57) ABSTRACT

An input device is provided using a capacitive input pad for performing diverse inputs and minimizing an area of a space for arranging a keyboard input unit and an input pad. A multiplex input unit is provided adjacent to input keys constituting a keyboard input unit. The multiplex input unit includes a large-scaled key, a detection switch of which an output is switched when the large-scaled key is pressed, and a capacitive input pad provided on a surface of the large-scaled key. A data processor generates different input signals depending on whether the detection switch is in an OFF state or an ON state when a finger touches the input pad for a manipulation.

### CLAIM OF PRIORITY

This application claims the benefit of Japanese Patent Application No. 2006-131155 filed May 10, 2006, the entire contents of which are incorporated herein by reference.

### BACKGROUND

1. Field of the Invention

The present invention relates to an input device, more particularly, to an input device capable of generating various input signals by combining a capacitive input pad with a switch.

2. Description of the Related Art

A capacitive input pad in which a plurality of X and Y electrodes are arranged in a matrix shape is disclosed in JP-A-1996-137607.

The X electrodes are arranged on one surface of a glass substrate and the Y electrodes are arranged on another surface of the glass substrate, on the input pad. The X and Y electrodes are arranged in a matrix shape with the glass substrate interposed therebetween so that a predetermined capacitance is formed between the X and Y electrodes, respectively.

The X electrodes are operable to be in a connectable state with a transmission circuit by a controller, and the Y electrodes can be at an ON state so that a predetermined electrical potential is applied to the X and Y electrodes. In this condition, when a conductor, such as a finger, touches the input pad, a static field occurs between the X and Y electrodes and a voltage variation is outputted from the Y electrodes in accordance with the variation of the static field. The voltage variation outputted from the Y electrodes is read by the controller through an A/D converter and the like. A voltage detector provided to the controller can detect coordinate information in regards to a position of the finger and the like. A position in which the static field between the X and Y electrodes varies is specified on the basis of data outputted from the A/D converter.

In a personal computer, the input pad and the keyboard input unit are disposed on a control board. A user can move a pointer on a screen and select a desired object, application, or function on a menu screen by manipulating the input pad with the finger when the user does not manipulate the keyboard input unit.

The known capacitive input pad recognizes a movement range of the finger as absolute coordinate data in coordinate X-Y after the finger touches a surface of the pad. Based on the absolute coordinate data, an input signal is generated as the movement information. Alternatively, based on the detected manipulation when the finger touches the surface of the pad and when the finger taps a button of a mouse, a click input signal is generated in response to a mouse button input signal corresponding to the tapping manipulation.

Accordingly, the input manipulation using the input pad is limited to moving the pointer, selecting the menu screen and the like on the displayed screen. Additionally, the input manipulation using the tapping manipulation is also limited to an input mode that is configured in advance. When the input manipulation using the input pad is executed for another purpose that is not configured in advance, it is necessary to call driver software installed in the personal computer so as to modify a configuration condition in an administration screen of the driver software. For example, when a drag manipulation is performed, a drag mode is required to be configured in the administration screen. Specifically, it is necessary for a common tapping manipulation, a tapping manipulation for a drag manipulation, and the like to be distinguished by changing the number (single tap and double tap) of touching the surface of the pad with a finger. Due to this, there is a limitation in using the pad input unit to execute various inputs.

Input keys of a keyboard input unit are arranged close to a display screen in a control board of the known personal computer. The input pad is disposed on a user side of a space input key in the keyboard input unit. Because of this, the area of the keyboard input unit and the input pad largely occupies a surface of the control board so that there is a limitation to achieve a decrease in size of the control board. When the area of the control board is decreased with the current arrangement, a size of the input keys of the keyboard input unit is decreased or the area of the input pad is decreased. Therefore, there is a problem in that the manipulation performance is degraded.

### BRIEF SUMMARY

According to a first aspects an input device includes an input pad operable to detect a contact with a manipulation body by the use of a variation in capacitance. A data processor is operable to analyze a contact position with the manipulation body on the input pad. Also included is a switch including an output operable to be switched when the input pad is pressed. The data processor is operable to generate different output signals when the output of the switch is switched and when the input pad detects the contact of the manipulation body without switching the output of the switch.

According to a second aspect, the input pad is provided with a keyboard input unit having a plurality of input keys. The data processor is operable to recognize that at least one of the input keys of the keyboard input unit is manipulated. The data processor is operable to generate a key input signal when the output of the switch is switched.

According to a third aspect, the data processor is operable to acquire a coordinate position where the manipulation body touches the input pad when the output of the switch is switched. The data processor is operable to generate the key input signal when it is recognized that the contact position with the manipulation body is in a specific key input region. The data processor is operable to ignore the switching of the output of the switch or operable to acquire the coordinate position where the manipulation body touches the input pad so as to generate a pad input signal when the contact position with the manipulation body is not in the key input region.

According to a fourth aspect, the data processor is operable to recognize that a space input key is manipulated and generates a space key input signal when the key input region is located in lines of the input keys of the keyboard input unit. The data processor is operable to recognize that the output of the switch is switched. The data processor is operable to recognize detection of the manipulation body touching the key input region.

According to a fifth aspect, the data processor is operable to acquire a coordinate position where the manipulation body touches the input pad is acquired and operable to generate a pad input signal when the output of the switch is not switched.

According to a sixth aspect, the pad input signal is at least one of a signal for moving a pointer on a display screen and a signal for scrolling a displayed state on the display screen.

According to a seventh aspect, the input pad is provided along a keyboard input unit having a plurality of input keys. A palm detecting section operable to detect a position of a hand at the time of manipulating the keyboard is provided in the keyboard input unit. The data processor is operable to generate a key input signal when the palm detecting section detects the hand and the output of the switch is switched. The data processor is operable to acquire a coordinate position where the hand touches the input pad and operable to generate a pad input signal when the palm detecting section does not detect the hand.

According to an eighth aspect, the data processor is operable to acquire the coordinate position where the hand touches the input pad when the palm detecting section detects the hand. The data processor is operable to generate an input signal corresponding to a specific region when it is recognized on the basis of the coordinate position that the specific region is manipulated.

According to a ninth aspect, the specific region is a mouse button input region and the input signal is a mouse button input signal.

According to a tenth aspect, the data processor is operable to generate an input signal for moving a pointer on a display screen in accordance with a movement of the contact position where the manipulation body touches the input pad when the output of the switch is not switched. The data processor is operable to generate a drag input signal when the output of the switch is switched.

According to an eleventh aspect, the data processor is operable to generate a scroll input signal for scrolling a displayed state in one direction on a display screen with a movement of the contact position where the manipulation body touches the input pad when the output of the switch is not switched. The data processor is operable to generate a scroll input signal for scrolling the displayed state in the opposite direction on the display screen with the movement of the contact position where the manipulation body touches the input pad when the output of the switch is switched.

According to a twelfth aspect, the data processor is operable to ignore a detection state when the output of the switch is not switched and upon detection that the manipulation body touches a position of a pad input section. The data processor is operable to generate a mouse button input signal when the output of the switch is switched and upon detection that the manipulation body touches the position of the pad input section.

According to a thirteenth aspect, the data processor is operable to generates different input signals when the output of the switch is not switched and upon detection that the manipulation body touches a position of a pad input section and when the output of the switch is switched and upon detection that the manipulation body touches the position of the pad input section.

Other systems, methods, features, and advantages of the invention will be, or will become, apparent to one with skill in the art upon examination of the following figures and detailed description. It is intended that all such additional systems, methods, features, and advantages be included within this description.

### BRIEF DESCRIPTION OF THE DRAWINGS

The components in the figures are not necessarily to scale, emphasis instead being placed upon illustrating the principles of the invention. Moreover, in the figures, like referenced numerals designate corresponding parts throughout the different views.

FIG. 1 is a top plan view illustrating an input device according to a first embodiment.

FIG. 2 is a sectional view illustrating the input device of FIG. 1 as shown in line II-II.

FIG. 3 is a top plan view illustrating an input device according to a second embodiment.

FIG. 4 is a sectional view illustrating a modified example of the input device according to the embodiments.

FIG. 5 is a sectional view illustrating a modified example of the input device according to the embodiments.

FIG. 6 is a block diagram illustrating a circuit configuration of one embodiment of the input device.

FIG. 7 is a flowchart illustrating a first control operation according to the first and second embodiments.

FIG. 8 is a flowchart illustrating a second control operation according to the first and second embodiments.

FIG. 9 is a top plan view illustrating an input device according to a third embodiment.

FIG. 10 is a sectional view illustrating the input device of FIG. 9 as shown in line X-X.

FIG. 11 is a flowchart illustrating a control operation according to the third embodiment.

### DESCRIPTION OF THE PREFERRED EMBODIMENTS

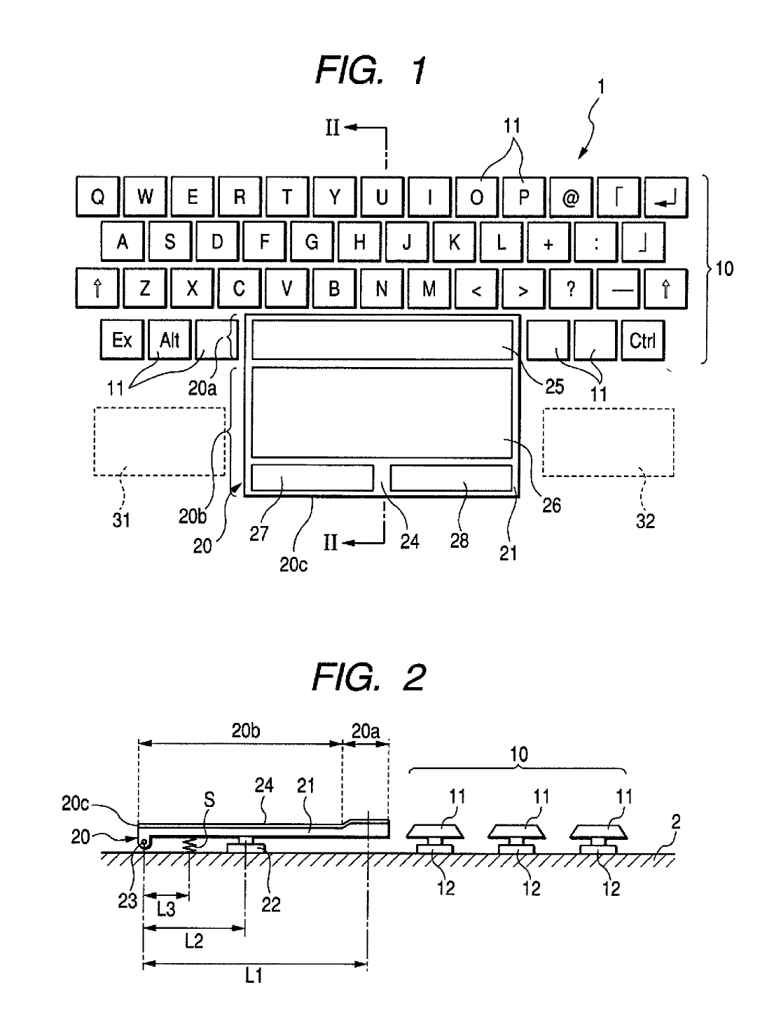

FIG. 1 is a top plan view illustrating an input device according to a first embodiment. FIG. 2 is a sectional view illustrating the input device of FIG. 1 as shown in line II-II.

An input device 1 is provided on a control board of a personal computer and can be appropriately provided on a control board of a small book-type personal computer. Additionally, the input device 1 can be used as a manipulation device for a game device, a television, and the like other than the personal computer. Hereinafter, the case in which the input device 1 is provided on the control board of the personal computer will be described.

As shown in FIG. 1, the input device 1 includes a keyboard input unit 10. The keyboard input unit 10 includes a plurality of input keys 11 that are regularly arranged. As shown in FIG. 2, a plurality of key switches 12 are arranged on a substrate 2 of the input device 1. The plurality of key switches 12 are formed under all input keys 11, respectively. When one input key 11 is pressed, an output of the key switch 12 corresponding to the input key 11 is switched from an OFF state to an ON state. As shown in FIG. 1, each input key 11 of the keyboard input unit 10 corresponds to an alphabet key, a shift key, an enter key, a control key, and the like.

The input device 1 includes a multiplex input unit 20. The multiplex input unit 20 is formed in a larger space compared to the input keys 11, such as the alphabet keys. As shown in FIG. 2, the multiplex input unit 20 includes a large-scaled key 21 with a rectangular shape. The large-scaled key 21 is retractably held by a holding shaft 23 formed on the substrate 2. Additionally, by allowing a portion of the large-scaled key 21 to be thin, the thin portion of the large-scaled key 21 can function as a hinge to hold the large-scaled key 21 instead of the holding shaft 23. The holding shaft 23 (or the hinge) is disposed distant from the input keys 11 constituting the keyboard input unit 10, and an end of the large-scaled key 21 that is close to the input keys 11 is a free end.

A detection switch 22 is provided on the substrate 2, and the switch 22 changes an output from an OFF state to an ON state when the large-scaled key 21 is pressed. The detection switch 22 is a pressing switch of a mechanical operation type. A reinforcement spring S, such as a compression coil spring, is provided between the detection switch 22 and the holding shaft 23 (or the hinge). A resisting force is exhibited due to a pressing resisting force between the reinforcement spring S and the detection switch 22 when the large-scaled key 21 is pressed.

In a surface of the large-scaled key 21, a region that is close to the input keys 11 of the keyboard input unit 10 is a first manipulation region 20a, and a region other than the first manipulation region 20a, that is, a rear edge portion on a user side in a region 23 in which the holding shaft 23 (or the hinge) is provided is a second manipulation region 20b. A length dimension of the first manipulation region 20a is substantially the same as that of the input keys 11 as shown in FIG. 1. That is, the first manipulation region 20a of the large-scaled key 21 is located in the first line on the user side of the input keys 11 of the keyboard input unit 10.

In a sectional shape of the large-scaled key 21 as shown in FIG. 2, the first manipulation region 20a is uplifted from the substrate 2. The second manipulation region 20b is uplifted but lower than the first manipulation region 20a, and the second manipulation region 20b is a flat surface in parallel to the surface of the substrate 2.

A capacitive input pad 24 is provided on a surface of the large-scaled key 21 in the range of the first manipulation region 20a to the second manipulation region 20b. The input pad 24 is formed of a resin film, and the resin film is attached to the surface of the large-scaled key 21 by an adhesive.

In the input pad 24, a plurality of X electrodes are provided on one surface of an insulation resin film having a predetermined permittivity in parallel, and a plurality of Y electrodes intersecting the X electrodes are provided on the other surface thereof in parallel. A detection electrode is provided between the adjacent X electrodes or between the adjacent Y electrodes. For example, a plurality of detection electrodes are provided between the adjacent X electrodes or between the adjacent Y electrodes with the same distance to each other. A cover of the resin film is provided on a top surface of the input pad 24.

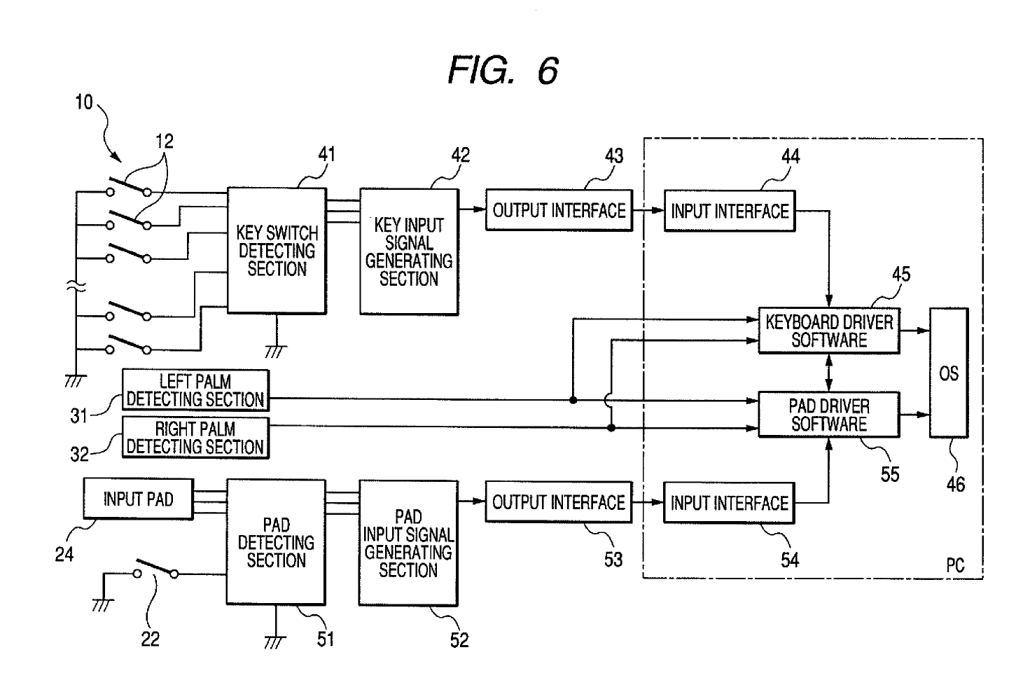

The X electrodes are sequentially selected by the driving circuit provided on a pad detection section 51 as shown in FIG. 6, and an electrical potential is applied to the selected X electrodes, while the X electrodes that are not selected is set to an earth potential. Additionally, the Y electrodes are sequentially selected after the X electrodes are selected, and the electrical potential is applied to the selected Y electrodes, while the Y electrodes that are not selected are set to the earth potential.

When the electrical potential is applied to the selected X electrodes, the voltage between the X electrode and the detection electrode is gradually increased with a time constant due to the capacitance between the selected X electrode and the detection electrode that is adjacent to the X electrode. At this time, the finger acting as a manipulation body of an electrical conduction body touches the cover. When the finger approaches the X electrode that gives the electrical potential, the capacitance is formed between the finger and the X electrode. Accordingly, the capacitance between the selected X electrode and the detection electrode is decreased, so that the voltage between the X electrode and the detection electrode is slowly increased. It is possible to analyze where the finger is in contact on the coordinate X by the use of the information about the selected X electrode and the detected value of the slow incensement of the voltage. Also, it is possible to analyze where the finger is in contact on the coordinate Y by the use of the information about the selected Y electrode and the detected value of the slow incensement of the voltage.

As shown in FIG. 1, a print is formed on the cover that covers the surface of the input pad 24 of the large-scaled key 21. A partition or a coloring through the print is formed on the first manipulation region 20a so as to distinguish a region of the space key input 25 from other region. In the second manipulation region 20b, substantially rectangular shaped pad input unit 26 is partitioned or colored. In front of the pad input section 26, an L-key input section 27 and an R-key input section 28 are partitioned or colored in left and right, respectively. In the embodiment, the L-key input section 27 and the R-key input section 28 are specific regions, respectively. The L-key input section 27 and the R-key input section 28 correspond to the main and auxiliary button of the mouse, that is, an external input device. The L-key input section 27 and the R-key input section 28 correspond to a button input region of the mouse.

In the control board, a cover formed of a compound resin is provided in a region other than the keyboard input device 10 and the multiplex input unit 20. In a lower side of the cover, a left palm detecting section 31 is provided in the left side of the multiplex input unit 20, and a right palm detecting section 32 is provided in the right side of the multiplex input unit 20. The left palm detecting section 31 and the right palm detecting section 32 are the same capacitive detection pad as the input pad 24. When a left hand is placed on the left palm detecting section 31, it is possible to detect that the left hand is placed on the cover. Likewise, when a right hand is placed on the right palm detecting section 32, it is possible to detect that the right hand is placed on the cover. Additionally, the left palm detecting section 31 and the right palm detecting section 32 can be configured as a plane-shaped pressure-sensitive switch.

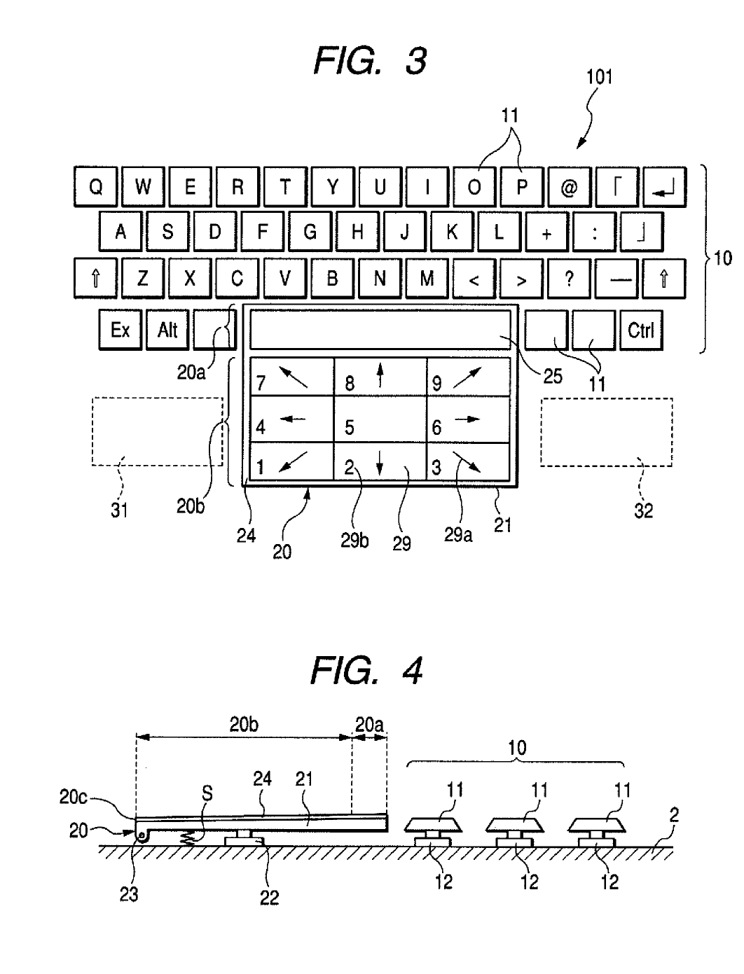

FIG. 3 is a top plan view illustrating an input device 101 according to a second embodiment.

The input device 101 has the same structure as the input device 1 according to the first embodiment. Accordingly, the same reference numerals will be used for the same configuration as the input device 1 according to the first embodiment, and the detailed description thereof will be omitted.

As shown in FIG. 3, in the multiplex input unit 20 of the input device 101, the capacitive input pad 24 is provided on a surface of the large-scaled key 21, but the print thereof is different from the input device 1 according to the first embodiment. In the input device 101, a space key input region 25 is formed on the first manipulation region 20a of the multiplex input unit 20 by the use of the print and the like. A compartment 29, which is divided into 9 parts, is printed or colored on the second manipulation region 20b, and an arrow mark 29a and a number mark 29b are printed in the compartment. In the embodiment, the divided parts of the compartment 29 are the specific region, respectively.

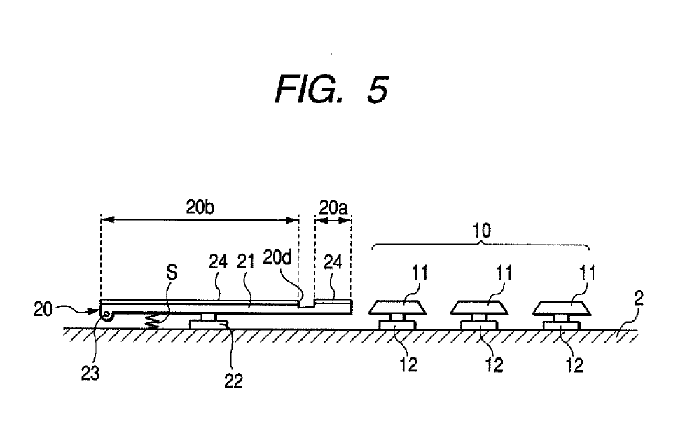

FIGS. 4 and 5 are sectional views illustrating modified examples of the input devices 1 and 101 according to the first and second embodiments, respectively.

In a modified example shown in FIG. 4, the first manipulation region 20a is a flat surface on the surface of the large-scaled key 21 and is substantially parallel to the surface of the substrate 2. The second manipulation region 20b is a flat surface gradually declining to the substrate 2.

In a modified example shown in FIG. 5, on the surface of the large-scaled key 21, a groove 20d is provided in a boundary between the first manipulation region 20a and the second manipulation region 20b, which is made to distinguish the first manipulation region 20a from the second manipulation region 20b by finger sensation. The first manipulation region 20a and the second manipulation region 20b are the flat surfaces parallel to the surface of the substrate 2.

In the modified examples shown in FIGS. 4 and 5, the capacitive input pad 24 is provided on the first manipulation region 20a and the second manipulation region 20b. Additionally, in the modified example shown in FIG. 5, because the groove 20d is formed in a part of the surface of the large-scaled key 21, the input pad 24 is notched in the groove 20d.

As shown in FIG. 2, in the embodiments and the modified examples, it is described that the range of a rotatable position formed of the holding shaft 23 (or the hinge) to the center of the first manipulation region 20a is expressed by L1, the range of the holding shaft 23 to an operation portion of the detection switch 22 is expressed by L2, and the range of the holding shaft 23 to an action portion of the reinforcement spring S is expressed by L3. They have a size difference as L3<L2<L1, and the sizes of L2 and L3 are below ½ of L1.

Because of this, when the first manipulation region 20a is pressed by the finger, the large-scaled key 21 is rotated with a relative small weight, so that the output of the detection switch 22 can be easily switched from an OFF state to an ON state. Accordingly, when palms of both hands are placed on the control board and the input keys 11 of the keyboard input device 10 are manipulated by the finger, for example, when the first manipulation region 20a is pressed by a thumb, the output of the detection switch 22 can be easily switched to an ON state.

Because the detection switch 22 and the reinforcement spring S are provided in the second manipulation region 20b, when the finger touches the second manipulation region 20b, the output of the detection switch 22 can not be switched unless the large-scaled key 21 is pressed by a strong force. Accordingly, it is difficult to switch the output of the detection switch 22 even when the finger touches the second manipulation region 20b and the finger slides in order to manipulate the input pad 24. However, when the palm is detached from the control board and the L-key input section 27 and the R-key input section 28 are strongly pressed by the finger, the output of the detection switch 22 can be switched to ON.

FIG. 6 is a block diagram illustrating a circuit configuration of the input devices 1 according to the first embodiment, the input device 101 according to the second embodiment, and the input device according to the modified examples.

In FIG. 6, a region that is surrounded by a dashed line is a configuration of a main body section of the personal computer.

An ON-OFF switching output of the key switch 12 of the keyboard input unit 10 is transmitted to a key switch detection section 41 provided in the keyboard input unit 10. A power source circuit for supplying current to the key switches 12 and a detection circuit for detecting the key switch 12 that is switched to an ON state are provided in the key switch detection section 41. The detected signal obtained from the key switch detection section 41 is transmitted to a key input signal generating section 42.

In the key input signal generating section 42, the key input signal as a switching signal of the key switch 12 that is sequentially manipulated is converted into a predetermined format, which is transmitted to an input interface 44 in the main body section PC of the personal computer through an output interface 43. Keyboard driver software 45 is installed in the main body section PC of the personal computer, and the key input signal is transmitted to a process operation of the keyboard driver software 45.

In a process operation of the keyboard driver software 45, the key input signal is converted into a keyboard input signal that is compatible with the standard OS (operating system) 46. The keyboard input signal is transmitted to the OS 46.

A detection output of the input pad 24 and a switching output of the detection switch 22 are transmitted to the pad detection section 51 that is provided on the input pad 24. A driving circuit is provided in the pad detection section 51. The driving circuit includes an X driver that gives an electrical potential by selecting the X electrode and a Y driver that gives an electrical potential by selecting the Y electrode. Additionally, a detection circuit is provided that detects a variation of the electrical potential between the electrode giving the electrical potential and the detection electrode in the pad detection section 51. Also, a detection circuit is provided that detects the detection output of the detection switch 22.

The detection output from the pad detection section 51 is transmitted to a pad input signal generating section 52 that is provided together on the input pad 24. In the pad input signal generating section 52, the manipulation position when the input pad 24 is manipulated by the finger is recognized as absolute coordinate data in the coordinate X-Y. A predetermined bit including the absolute coordinate data and the detection output of the detection switch 22 is transmitted to the input interface 54 in the main body section PC of the personal computer through the output interface 53.

In the main body section PC of the personal computer, pad driver software 55 is installed, and the input signal in the input interface 54 is transmitted to the process operation of the pad driver software 55. In the process operation by using the pad driver software 55, absolute coordinate data in the coordinate X-Y from the pad input signal generating section 52 is converted into coordinate data that is compatible with the standard OS 46. The coordinate data is transmitted to the OS 46. For example, in the pad driver software 55, the absolute coordinate data from the pad input signal generating section 52 is converted into relative coordinate data indicating a movement direction and distance in the coordinate X-Y when the finger contacting region on the input pad 24 is moved X-Y. The relative coordinate data is transmitted to the OS 46. Additionally, the process operations of the pad driver software 55 and the keyboard driver software 45 are related to each other. When the output of the detection switch 22 is switched on the basis of a predetermined condition, the information is transmitted from the pad driver software 55 to the keyboard driver software 45.

It is preferable that the detection switch 22 is included in a part of the keyboard unit 10 in the circuit. The switching output of the detection switch 22 is transmitted to the processor of the keyboard driver software 45. The state of the detection switch 22 is detected by using the keyboard driver software 45. Also, an input signal is generated on the basis of the variation of the state.

The detection signals of the left palm detecting section 31 and the right palm detecting section 32 are transmitted to the processors of the keyboard driver software 45 and the pad driver software 55 that are installed in the main body of the personal computer. The left palm detecting section 31 and the right palm detecting section 32 are capacitive detection pads like the input pad 24. Accordingly, a circuit corresponding to the pad detection section 51 and the pad input signal generating section 52 is connected to the left palm detecting section 31 and the right palm detecting section 32. Additionally, the output interface and the input interface are provided that transmit signals to the keyboard driver software 45 and the pad driver software 55, but these circuits are omitted in FIG. 6.

According to the embodiments, the process operations of the keyboard driver software 45 and the pad driver software 55 mainly correspond to a data processor.

Next, a first control operation that uses the input device 1 according to the first embodiment, the input device 101 according to the second embodiment, and/or the input device according to the modified examples will be described. The first control operation uses the detection output about the hand by the use of the left palm detecting section 31 and the right palm detecting section 32.

In an initial configuration of the input device, various environment configurations are performed on administration screens related to drivers on the display screen by activating the keyboard driver software 45 or the pad driver software 55. The environment configuration includes a configuration of a palm detecting mode.

In a configuration of the palm detecting mode, when the left hand of the user is placed on the left palm detecting section 31 so as to manipulate the keyboard input unit 10, a detection output, that is, information about the position of the left hand is generated by the capacitive left palm detecting section 31. The detection output is transmitted to the processor of the keyboard driver software 45 or the processor of the pad driver software 55 so that the detection output is memorized therein. Additionally, when the right hand of the user is placed on the right palm detecting section 32 so as to manipulate the keyboard input unit 10, the detection output at this time is transmitted and memorized in the same way as described above. After the environment configuration, when the left palm detecting section 31 detects the hand, detected information is compared with the memorized information so as to estimate whether they coincide with each other within a predetermined percentage. Based on the compared result, it is possible to judge whether the left hand is placed thereon so as to manipulate the keyboard input device 10. This method may be performed in the same way for the right hand.

In the manipulation of the environment configuration, as detection information in regards to the palm is memorized, area data in coordinate X-Y indicating the total area of a contact pattern when the palm touches the surface of the control board can be used. Also, sample information may be used that is sampled as several signals in coordinate X-Y from the detection signal obtained from the left palm detecting section 31 or the right palm detecting section 32 when the palm touches the control board.

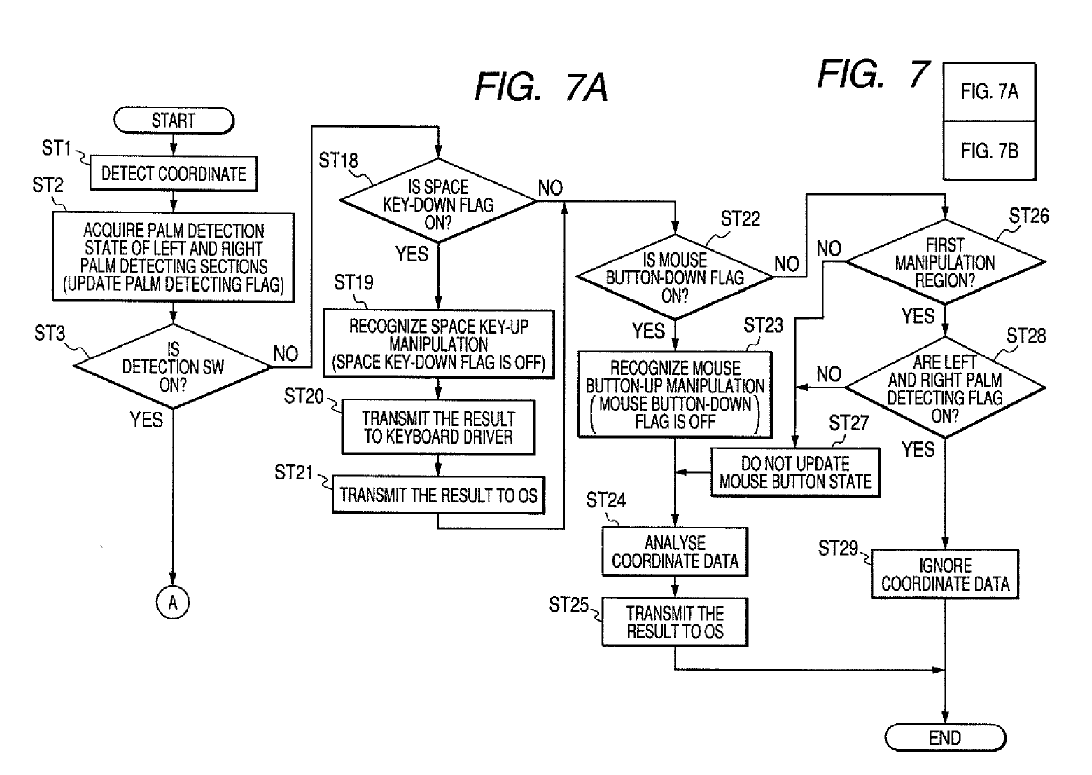

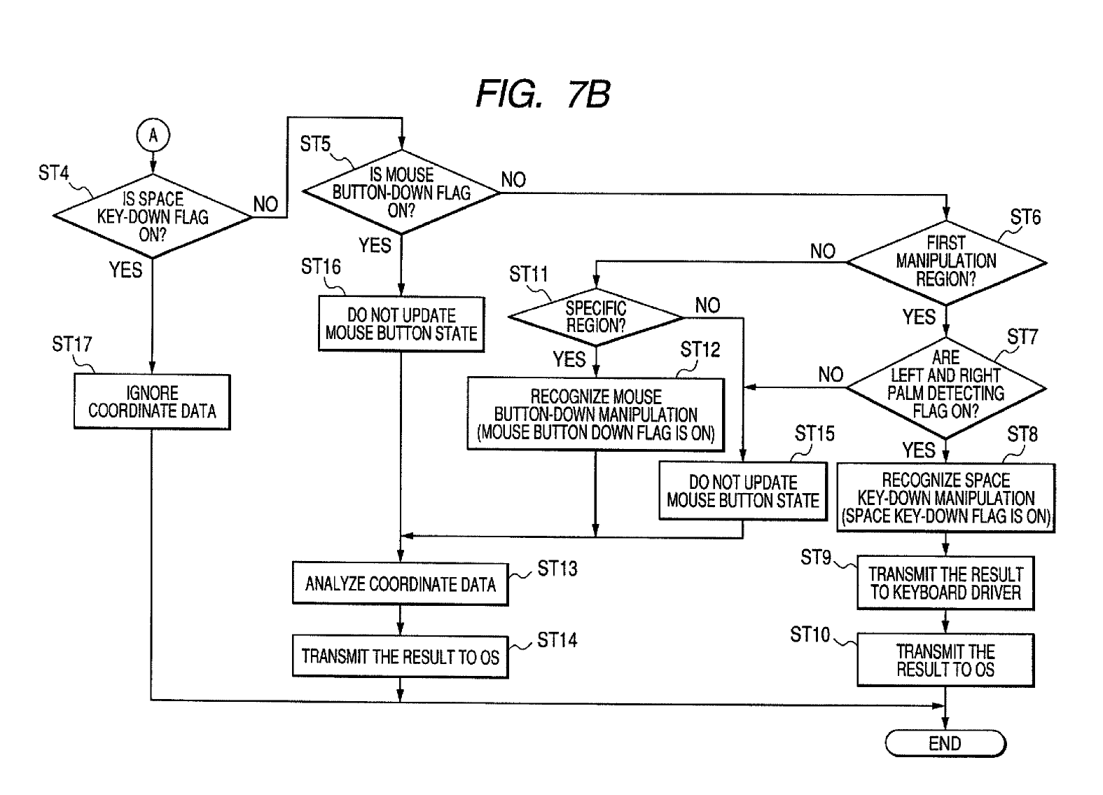

FIG. 7 is a flowchart illustrating the first control operation when the input device 1 shown in FIGS. 1 and 2 is used. In FIG. 7, each step is denoted as ST. A control process shown in FIG. 7 is performed on the basis of the response of the polling from the pad driver software 55 to the pad detection section 51 for the input pad 24 and the pad detection section for the left palm detecting section 31 and the right palm detecting section 32. The operation flow shown in FIG. 7 denotes one time polling operation, and the operation flow is repeated.

The control operation shown in FIG. 7 is started by the trigger when a finger touches the input pad 24.

When the finger touches the input pad 24 and the coordinate detection signal is transmitted from the input pad 24 to the pad driver software 55 in ST 1, a palm detecting is performed by the left palm detecting section 31 and the right palm detecting section 32 in ST 2. The result of the palm detection from the left palm detecting section 31 and the right palm detecting section 32 is stored in a palm detecting flag.

Whether the detection switch 22 is in an ON state is monitored in ST 3. When it is judged that the detection switch 22 is in an ON state in ST 3, the following process is performed.

When the processor of the pad driver software 55 judges that the detection switch 22 is in an ON state in ST 3, it is judged whether the space key-down flag is in an ON state, that is, whether the detection switch outputs the space key input signal to the OS 46 due to the polling of the last step in ST 4. When the space key-down flag is not in an ON state in ST 4, the present step is moved to ST 5. Whether the mouse button-down flag is in an ON state is judged or determined, that is, whether the detection switch outputs the key input signal (a left click signal) indicating the manipulation of the L-key input section 27 functioning as the mouse button or the key input signal (a right click signal) indicating the manipulation of the R-key input section 28 functioning as the mouse button due to the polling of the last step.

When it is judged that the mouse button-down flag is not in an ON state in ST 5, the present step is moved to ST 6. Whether the coordinate position detected by the current input pad 24 is the first manipulation region 20a as shown in FIG. 1 is monitored. When the current position is the first manipulation region 20a, that is, the space key input region 25 in ST 6, the present step is moved to ST 7. Whether both detection flags of the left palm detecting section 31 and the right palm detecting section 32 are in an ON state is monitored. When both detection flags are in an ON state, that is, both hands manipulate the keyboard input device, the present step is moved to ST 8, and the space key-down flag becomes an ON state. At this time, the key input signal is transmitted from the processor of the pad driver software 55 to the processor of the keyboard driver software 45 in ST 9. Additionally, the key input signal is transmitted to the OS 46 in ST 10.

When the space key-down flag is in an ON state, in the next polling, the control process is performed from ST 4 to ST 17. In the processor of the pad driver software 55, the coordinate detection data generated by the manipulation of the finger on the input pad 24 is ignored, and the space key input signal is treated as a valid signal.

When the detection switch 22 is in an ON state and the space key-down flag and the mouse button-down flag are not in an ON state, it is judged that the finger in contact with the input pad 24 is not the first manipulation region 20a in ST 6. The present step is moved to ST 11. Whether the region contacting the finger is the specific region is judged or determined, that is, the L-key input section 27 or the R-key input section 28. When the region contacting the finger is the specific region, the present step is moved to ST 12, and the mouse down flag becomes an ON state. Next, the present step is moved to ST 13, and the processor of the pad driver software 55 analyzes the coordinate region contacting the finger on the input pad 24. When the finger touches the L-key input section 27, the present step is moved to ST 14, and the pad driver software 55 notifies the OS 46 of the left click signal. When the region contacting finger is the R-key input section 28 in ST 13, the pad driver software 55 notifies the OS 46 of the right click signal in ST 14.

When it is judged that the finger contacting region on the input pad 24 is not the first manipulation region 20a in ST 6 and the finger contacting region is not the specific region (the L-key input section 27 or the R-key input section), that is, when the finger contacting region is the pad input section 26 in ST 11, the present step is moved to ST 15, and the operation state of the mouse button (the L-key input section 27 and the R-key input section 28) is not updated, that is, it is judged that the mouse button is not manipulated. At this time, the present step is moved to ST 13, the coordinate position in which the finger contacts the pad input section 26 is transmitted to the OS 46 in ST 14. In this case, the pad driver software 55 transmits the current pad input signal to the OS 46, and thus the user can move the pointer and the like displayed on the screen with the finger and scrolls a character string and the like on the screen.

When it is judged that the finger contacting region on the input pad 24 is the first manipulation region 20a in ST 6 and both left palm detecting section 31 and right palm detecting section 32 do not detect the finger in ST 7, that is, both hands does not touch the control board or one hand touches the control board, the present step is moved to ST 15. The operation state of the mouse button is not updated in the present step, and the present step is moved to ST 13. The coordinate position of the finger is detected in ST 13, and the current pad input signal is transmitted the OS 46 in ST 14.

When the detection switch 22 is in an ON state and it is judged that the mouse button-down flag is in an ON state in ST 5, the present step is moved to ST 16. Because the mouse button input signal is already transmitted to the OS 46 in the polling of the last step, the operation state of the mouse button is held as it is. Whether the finger touches the L-key input section 27 or the R-key input section 28 is judged or determined in ST 13, and the left click signal or the right click signal is transmitted from the pad driver software 55 to the OS 46 in ST 14.

When the detection switch 22 is in an OFF state in ST 3, the next control flow is executed.

Whether the space key-down flag is in an ON state is judged or determined in ST 18. When the flag is in an ON state, that is, the space key input signal is transmitted to the OS 46 due to the polling of the last step, the present step is moved to ST 19. The processor of the pad driver software 55 judges that the space key input is cleared, and the space key-down flag becomes an OFF state, which is transmitted from the processor of the pad driver software 55 to the processor of the keyboard driver software 45 in ST 20. The result is transmitted to the OS 46 in ST 21, and the present step is moved to ST 22.

When the space key-down flag is in an OFF state in ST 18, that is, the space key input signal is not transmitted to the OS 46, the present step is moved to ST 22, and whether the mouse button-down flag is in an ON state is monitored. When the mouse button-down flag is in an ON state, that is, the left click signal or the right click signal is transmitted to the OS 46 due to the polling of the last step, the present step is moved to ST 23, and the processor of the pad driver software 55 judges that the mouse button input corresponding to the input on the basis of the manipulation of the L-key input section 27 or the R-key input section 28 is cleared, and so the mouse button flag becomes an OFF state. The present step is moved to ST 24. The processor of the pad driver software 55 analyzes the manipulation position of the finger on the input pad 24 on the basis of the coordinate detection data. The current pad input signal is generated in ST 25, and the result is transmitted to the OS 46.

When the mouse button-down flag is in an OFF state in ST 22, whether the finger contacting region is the first manipulation region 20a of the input pad 24 is judged or determined in ST 26. When the finger contacting region is not the first manipulation region 20a, the present step is moved to ST 27. The current state of the mouse button is not updated, and the present step is moved to ST 24. A coordinate detection with respect to the finger contacting region is executed, and the pad input signal is generated. The result is transmitted to the OS 46 in ST 25.

When it is judged that the finger contacting region is not the first manipulation region 20a but one of the second manipulation regions 20b in ST 26, the present step is moved to ST 28. When the left palm detecting section 31 and the right palm detecting section 32 do not detect the hand, that is, both hands are not touching the control board or one hand touches the control board in ST 28, the present step is moved to ST 27, ST 24, and ST 25. The pad input signal is transmitted to the OS 46.

When the left palm detecting section 31 and the right palm detecting section 32 detect both hands in ST 28, the present step is moved to ST 29. In the process operation of the pad driver software 55, the coordinate detection signal from the input pad 24 is ignored.

In the control process, when the space key input signal is transmitted to the OS 46, a process that makes a space in the character string displayed on the screen of the display unit of the personal computer is executed. When the current pad input signal is transmitted to the OS 46, a process moves a pointer on the screen or scrolls contents displayed on the screen. When the right click signal or the left click signal is transmitted to the OS 46, a booting process, an open process, and the like in the menu screen are executed on the basis of a signal process that is previously configured in the pad driver software 55 and the OS 46.

In the control process as shown in FIG. 7, both left palm detecting section 31 and right palm detecting section 32 detect whether the hand manipulates the keyboard input device 10. At this time, when the detection switch 22 is in an ON state and the finger contacting region is the first manipulation region 20a, the space key input signal is transmitted to the OS 46. Additionally, when the detection switch 22 is in an ON state and the finger contacting region is the L-key input section 27 or the R-key input section 28, the left click signal or the right click signal is generated independent of whether the left palm detecting section 31 and the right palm detecting section 32 detect the hands. When the detection switch 22 is in an ON state and both hands do not touch the control board or one hand touches the control board, the coordinate data can be inputted from both first manipulation region 20a and pad input section 26 (the pad input signal can be transmitted). Additionally, when the detection switch is in an ON state and it is judged that the hand contacting region is not the first manipulation region 25, the L-key input section 27, and the R-key input section 28 but the pad input region 26, the detection output of the detection switch 22 may be ignored and the coordinate detection data from the input pad 24 may be ignored as well.

When the detection switch 22 is in an OFF state and both left palm detecting section 31 and right palm detecting section 32 detects that the hand manipulates the keyboard input unit 10, the input of the coordinate data from the input pad 24 is ignored. When both hands do not touch the control board or one hand touches the control board, the total surface of the input pad 24 can be used for the input of the coordinate data, that is, the generating of the pad input signal.

Next, the first control operation using the input device 101 according to the second embodiment as shown in FIG. 3 will be described. That is, a control operation using the detection output from the left palm detecting section 31 and the right palm detecting section 32 will be described.

In the input device 101, there are 2 types of operation modes when the compartment 29 as the specific region is manipulated. A first configuration mode denotes different inputs in accordance with the arrow mark 29a shown in the compartment 29. The inputs are the same as the shift arrow keys provided in the current keyboard input unit. A second configuration mode denotes nine partitioned inputs in accordance with the number mark 29b shown in the compartment 29. The inputs are the same as the numeric keypad provided in the current keyboard input unit.

The input information of the compartment 29 is executed in one of two configuration modes as described above, which is decided by activating the pad driver software 55 so as to display the administration screen and perform the input in the environment configuration.

The control operation uses the input device 101 according to the second embodiment as shown in FIG. 3. The control operation replaces the mouse button (the L-key input section 27 and the R-key input section 28) of the control flow shown in FIG. 7 with the manipulation of the compartment 29. The mouse button-down flag in FIG. 7 is replaced with a manipulation flag of the compartment 29.

As shown in FIG. 7, when it is judged that the finger contacting region on the input pad 24 is the first manipulation region 20a in ST 6 and both left palm detecting section 31 and right palm detecting section 32 detect the palm in ST 7, the present step is moved to ST 8, and the space key-down flag becomes an ON state.

When it is judged that the finger contacting region is not the first manipulation region 20a in ST 6 and the finger contacting region is in the compartment 29 in ST 11, the manipulation flag of the compartment 29 becomes an ON state in ST 12 and where the finger is placed in the compartment 29 is detected in ST 13.

When the pad driver software 55 is executed in the first configuration mode, the detection switch 22 is in an ON state, and the finger contacting region is in the region of the arrow mark 29a in the compartment 29 in ST 13. The result is transmitted from the processor of the pad driver software 55 to the processor of the keyboard driver software 45. The same input signal as the manipulation signal of the up, down, left, and right arrow keys or the tilt up, tilt down, tilt left, and tilt right arrow keys provided in the current keyboard input unit 10 is transmitted from the keyboard driver software 45 to the OS 46. When an arrow mark region indicating the up direction is manipulated, for example, a consol displayed on the screen is moved upward. When an arrow mark region indicating the down direction is manipulated, for example, the console displayed on the screen is moved downward. Alternatively, an up sequential hunting or a down sequential hunting in a pull-down menu is executed. When an arrow mark region indicating the left direction or the right direction is manipulated, for example, a character selecting position in the character string displayed on the screen is sequentially shifted left and right. Alternatively, the menu in the menu screen is sequentially selected left and right. Additionally, when it is judged that the finger contacting region is in contact with a tilt up or tilt down arrow key, the image displayed on the screen moves in the tilt direction.

When the pad driver software 55 is executed in the second configuration mode, the detection switch 22 is in an ON state, and the finger contacting region is in contact with the number mark 29b in the compartment 29 in ST 13. The result is transmitted from the processor of the pad driver software 55 to the keyboard driver software 45. The same input signal as the manipulation input signal of the numeric keypad provided in the current keyboard input unit 10 is transmitted from the keyboard driver software 45 to the OS 46. Due to the input by the numeric keypad, numbers are displayed on the screen or a calculation using a number is executed.

Additionally, the operation when the detection switch 22 is not in an ON state is the same as the control operation shown in the control operation in FIG. 7. When the detection switch 22 is in an OFF state, and the palm detecting sections 31 and 32 do not detect the hands or the palm detecting sections detect one hand, the total surface of the input pad 24 in which the large-scaled key 21 is provided is used as the coordinate input region (the pad input region) in ST 24, and the pad input signal is transmitted to the OS 46. Because the total surface of the input pad 24 is used as the pad input region, the coordinate input manipulation can be easily executed even though the multiplex input unit 20 has a small area.

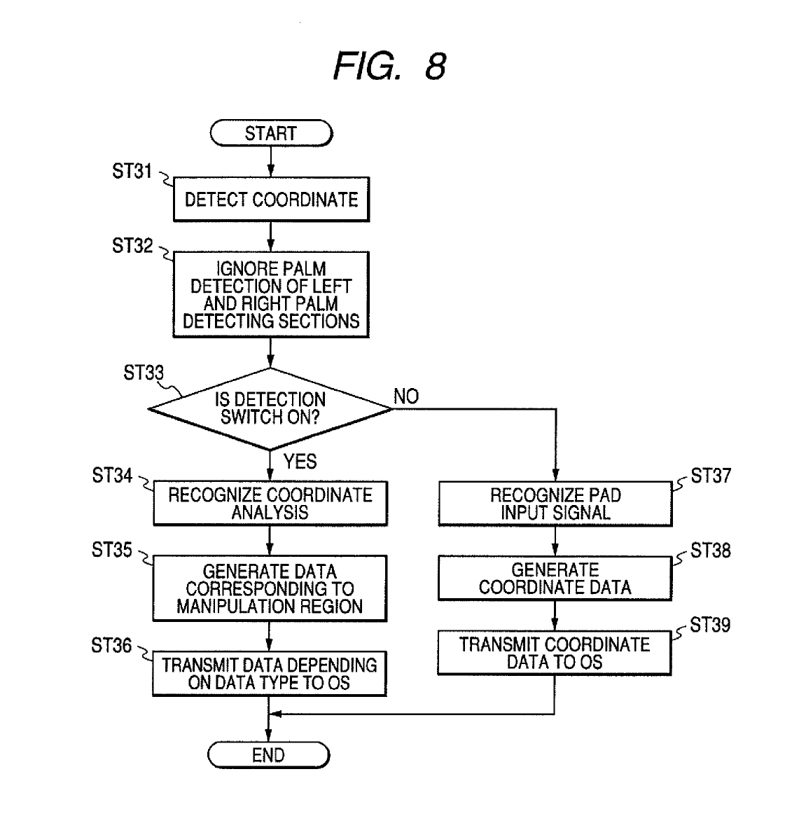

Next, a second control operation will be described using the input device 1 according to the first embodiment, the input device 101 according to the second embodiment, or the input device according to the modified example with reference to the flowchart shown in FIG. 8.

The second control operation does not use the detection output of the left palm detecting section 31 and the right palm detecting section 32, but the second control operation uses the detection output of the detection switch 22 in order to recognize whether the space key input is executed. In the manipulation of the environment configuration, the second control operation can be executed by activating the pad driver software 55 so as to display the administration screen on the screen and perform a configuration that does not use the left palm detecting section 31 and the right palm detecting section 32. Due to the configuration, the detection signal of the left palm detecting section 31 and the right palm detecting section 32 is ignored.

The control flow is started by using the trigger when the finger touches the input pad 24.

As shown in FIG. 8, when it is judged that the pad driver software 55 acquires the coordinate detection data from the input pad 24 in ST 31 and the mode ignores the detection data of the left palm detecting section 31 and the right palm detecting section 32 in ST 32, the processor of the pad driver software 55 monitors whether the detection switch is in an ON state in ST 33. When the output of the detection switch 22 is switched to an ON state in ST 33, the present step is moved to ST 34. The processor of the pad driver software 55 analyzes where the finger touches the input pad 24 and the present step is moved to ST 35.

The pad driver software 55 generates data on the basis of the region where the finger touches the input pad 24 in ST 35, and each data is transmitted to the OS 46 in ST 36.

When it is judged that the finger contacting region is the space key input region 25 of the first manipulation region 20a in ST 34, the result is transmitted from the processor of the pad driver software 55 to the processor of the keyboard driver software 45. In the keyboard driver software 45, the input signal that the space key input is executed is transmitted to the OS 46.

When the detection switch 22 is in an ON state and the finger contacting region is in contact with the L-key input section 27 or the R-key input section 28 shown in the input device 1 in FIG. 1, the processor of the pad driver software 55 transmits the same signal as the input signal of the main or auxiliary button of the mouse to the OS 46.

When it is judged that the detection switch 22 is in an ON state and the coordinate poison of the finger contacting region is in contact with the input pad 24 is the pad input section 26 in the input device 1, the processor of the pad driver software 55 transmits the pad input signal that is generated by the coordinate information of the finger contacting region and the coordinate information when the finger is moved in the pad input section 26 to the OS 46. Due to the transmission, the OS 46 executes the same process operation as the mouse manipulation. Alternatively, when the detection switch 22 is in an ON state, the coordinate detection data of the finger which touches the pad input section 26 may be ignored.

When the input device 101 according to the second embodiment as shown in FIG. 3 is used, the detection switch 22 is in an ON state, and the finger contacting region on the input pad 24 is the space key input region 25 as shown in FIG. 3 in ST 35, the space key input signal is transmitted to the OS 46. Additionally, when it is judged that the finger contacting region is in the compartment 29 in ST 35, it is judged that the numeric keypad input is executed on the basis of the number mark 29b, and the numeric keypad input signal is transmitted to the OS 46. Alternatively, the same input signal as the manipulation input signal of the up, down, left, and right arrow keys or the tilt up, tilt down, tilt left, and tilt right arrow keys is transmitted from the keyboard driver software 45 to the OS 46 on the basis of the arrow mark 29a.

When it is judged that the detection switch 22 is in an OFF state in ST 33, the present step is moved to ST 37. In both input device 1 as shown in FIG. 1 and input device 101 as shown in FIG. 3, the total surface of the input pad 24 is used as the coordinate input section. In the processor of the pad driver software 55, the pad input signal is generated from the coordinate input signal in ST 38, and the pad input signal is transmitted to the OS 46.

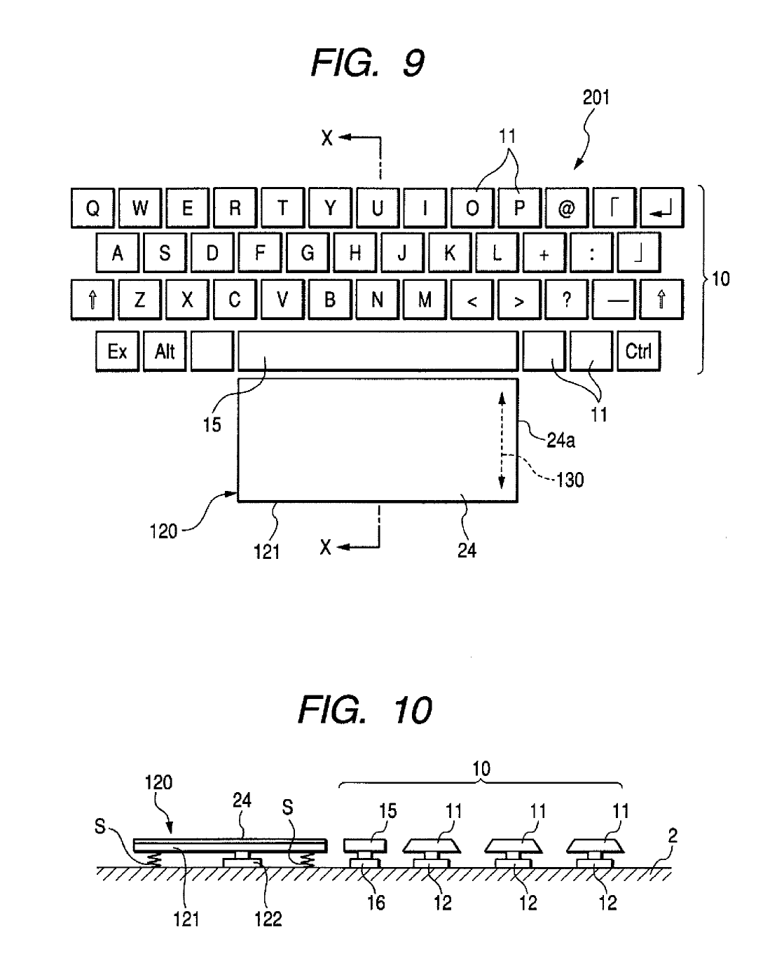

FIG. 9 is a top plan view illustrating an input device 201 according to a third embodiment. FIG. 10 is a sectional view illustrating the input device of FIG. 9 shown in line X-X.

In the input device 201, input keys 11 such as an alphabet key are provided in the keyboard unit 10, and a thin and longitudinal space input key 15 is provided in the first line on a hand side of the keyboard unit. As shown in FIG. 10, the key switches 12 of which the output is switched by the input keys 11 and the space key switch 16 of which the output is switched by the space input key 15 are provided on the substrate 2 of the keyboard input unit 10.

Additionally, a multiplex input unit 120 is provided in front of the space input key 15. As shown in FIG. 10, a large-scaled key 121 is provided in the multiplex input unit 120. The large-scaled key 121 is held by a holding mechanism (not shown) so as to move up and down. A detection switch 122 of which a output is switched by the large-scaled key 121 and the reinforcement spring S is provided on the substrate 2 so as to maintain a posture of the large-scaled key to be moved in parallel to the substrate 2 when the large-scaled key 121 is pressed. Due to a reaction force of the detection switch 122 at the time of a manipulation and an elastic force of the reinforcement spring S, a resisting force at the time of pressing the large-scaled key 121 is highly set to a certain degree. The capacitive input pad 24 is fixed to the total surface of the large-scaled key 121 by the use of an adhesive and the like.

In the input device 201, the space input key 15 is provided in the keyboard input unit 10. The space input key 15 is used for the input of the space key input in the same way as the current keyboard input unit. Additionally, it is possible for the multiplex input unit 120 to input various inputs by the use of the detection output of the input pad 24 and the detection switch 122. That is, different input signals are generated when the detection switch 122 is not operated and the finger touches the surface of the input pad 24 or the finger is moved while the finger touches thereon and when the output of the detection switch 122 becomes an ON state by pressing the input pad 24 and the finger touches the surface of the input pad 24 or the finger is moved while the finger is in contact therewith.

The control circuit of the input device 201 as shown in FIGS. 9 and 10 is the same as the control circuits of the input devices 1 and 101 according to the first and second embodiments as shown in FIG. 6.

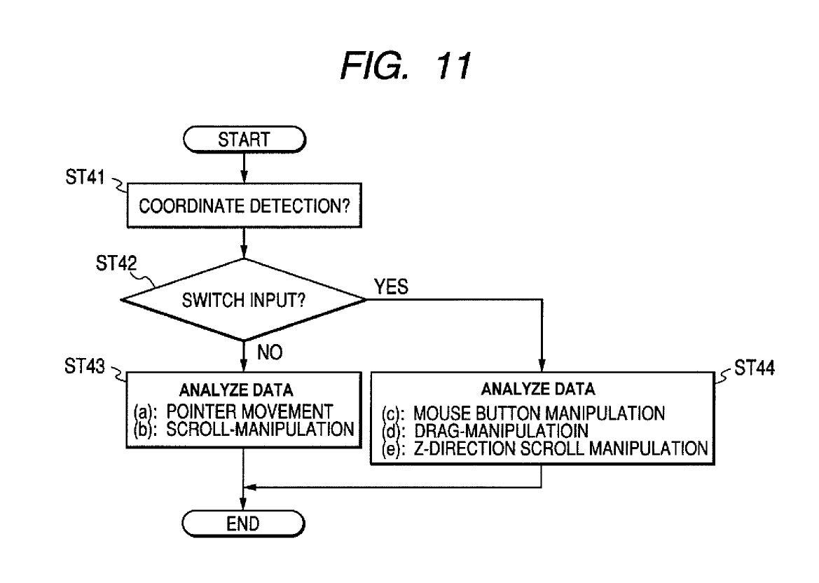

FIG. 11 is a flowchart illustrating a control operation of the input device 201.

In the control operation, when the coordinate detection signal is obtained from the input pad 24 in ST 41, the present step is moved to ST 42, and whether the detection switch 122 becomes an ON state is monitored. When the finger slightly touches the input pad 24 for a manipulation, the detection switch 122 does not become an ON state and at this time the present step is moved to ST 43. Because the detection switch 122 becomes an ON state when the finger strongly presses the input pad 24 for the manipulation, at this time the present step is moved to ST 44. The processor of the pad driver software 55 generates a different pad input signal on the basis of the absolute coordinate data obtained from the pad input signal generating section 52, and the different pad input signal is transmitted to the OS 46 in ST 43 and 44.

For example, when the finger slightly touches a position of the input pad 24 and the detection switch 122 is in an OFF state, at that time the detection signal from the input pad 24 in a formal manipulation is ignored in ST 43, and any input signal is transmitted to the OS 46. Meanwhile, when the finger touches a position of the input pad 24 and the detection switch 122 becomes an ON state by strongly pressing the large-scaled key 21 with the finger, it is recognized that the input is the same click manipulation of the main button of the mouse in ST 44. The same signal as the main button of the mouse is transmitted to the OS 46.

The main button input signal is the same manipulation signal as when the main button of the mouse is pressed or when the L-key input section 27 as shown in FIG. 1 is manipulated. Alternatively, the main button input signal may be the same manipulation signal as when the R-key input section 28 is manipulated. Alternatively, the main button input signal may be the same manipulation signal as when the tapping manipulation (quickly tapping the input pad 24) is performed on the current capacitive input pad.

As another process operation, when it is detected that the finger is slightly in contact with a position of the input pad 24 and the detection switch 122 is in an OFF state, the same input signal is generated as when the main button of the mouse is pressed, the L-key input section 27 shown in FIG. 1 is manipulated, or the tapping manipulation is performed one time in the current capacitive input pad. The input signal is transmitted to the OS 46 in ST 43. Meanwhile, when it is detected that the finger touches the input pad 24 and the detection switch 122 becomes an ON state by strongly pressing a position of the input pad 24 with the finger, the same input signal is generated as when the auxiliary button of the mouse is pressed, the R-key input section 28 shown in FIG. 1 is manipulated, or the tapping manipulation is performed two times in the current capacitive input pad. The input signal is transmitted to the OS 46 in ST 44.

As mentioned above, when it is detected that the finger touches a position of the input pad 24 and the detection switch 122 is in an OFF state, the input signal is not generated. When it is detected that the finger touches a position of the input pad 24 and the detection switch 122 is in an ON state, an operation mode occurs in which the input signal is generated. Alternatively, when it is detected that the finger touches a position of the input pad 24 and the detection switch 122 is in an OFF or ON state, an operation mode occurs in which the input signal is generated and a different mouse input signal is generated.

Additionally, in the manipulation of the environment configuration, a predetermined region of the input pad 24 can be configured as a specific region for performing a specific manipulation by activating the pad driver software so as to display the administration screen. In the example shown in FIG. 9, the thin and longitudinal region along a right edge 24a of the input pad 24 is configured as the specific region.

For instance, a generation of the input signal in the state that the finger slides up and down along an arrow 130 when the finger touches a region within the right edge 24a of the input pad 24 will be described. When the finger touches the region within the right edge 24a of the input pad 24 and the finger slides up and down along an arrow 130, when the contact pressure of the finger is small, and when the detection switch 122 is in an OFF state, the processor of the pad driver software 55 generates the scroll input signal. The scroll input signal is transmitted to the OS 46 in ST 43. When the OS 46 receives the scroll input signal, a control process is performed that moves up and down the character string and the like displayed on the screen.

Meanwhile, when the detection switch 122 is in an ON state by strongly pressing the input pad 24 with the finger and it is detected that the finger slides in the direction of the arrow 130, a scroll input signal having a different type or a different direction relative to when the detection switch 122 is in an OFF state is generated and the result is transmitted to the OS 46. For example, when the finger slides along the direction of the arrow 130 while the detection switch 122 is in an ON state, a size of an object or a character displayed on the screen is changed as if the object or the character moves from the rear screen to the front screen, that is, in Z direction in ST 44.

Transmission rates of the scroll input signals of when the finger slides along the direction of the arrow 130 while the detection switch 122 is in an OFF state and when the finger slides along the direction of the arrow 130 while the detection switch 122 is an ON state that are transmitted to the OS 46 may be changed. As a result, when the detection switch 122 is in OFF and ON states, a scroll speed of the character string and the like displayed on the screen can be changed. For example, when the detection switch 122 is in an OFF state, the scroll speed is configured to be slow. When the detection switch 122 is in an ON state, the scroll speed is configured to be fast.

Alternatively, when the finger slides in the direction of the arrow 130 while the detection switch 22 is in an ON state, the scroll signal may be transmitted to the OS 46.

In another control operation, when the finger is slightly in contact with the input pad 24 and the finger slides on the surface of the input pad 24 while the detection switch 122 is in an OFF state, the processor of the pad driver software 55 generates the coordinate data indicating the manipulation of the current pointer movement in ST 43. The result is transmitted to the OS 46. In this manipulation, for example, the pointer displayed on the screen is moved corresponding to the direction in which the finger slides. Alternatively, at this time, the scroll signal may be generated.

When the finger slides on the surface of the input pad 24 while the switch 122 is in an ON state by strongly pressing the input pad 24 with the finger, the processor of the pad driver software 55 generates a pointer moving manipulation (a drag) input signal having a mouse button pressing information in ST 34. The result is transmitted to the OS 46. When the drag input signal is transmitted to the OS 46, an operation process is performed in which a window and the like, which is displayed and indicated by the pointer displayed on the screen, is moved corresponding to the direction of the sliding finger. Additionally, when the detection switch 122 is switched from an ON state to an OFF state by slightly pressing the input pad 24, the drag is cleared.

It is an object of the invention to provide an input device capable of performing various manipulation inputs through an input pad without frequently changing a configuration condition.

Additionally, it is another object of the invention to provide an input device that can contribute to a decrease in size of a control board of a personal computer and the like because a keyboard input device can be provided close to an input pad.

According to the embodiments, the input device includes a switch of which the output is switched at the time of pressing the input pad. In accordance with the switching of the output of the switch, it is possible to recognize the type of the input when the input pad is manipulated. Thus, it is possible to perform a diverse input manipulation using the input pad. The switch is not limited to a pressing switch of a mechanical operation type described in the embodiment. It is possible to use an optical switch that uses an optical detection element, a magnetic detection switch that detects the approaching input pad when the input pad is pressed, and the like. That is, it is possible to use any switch capable of performing a detection operation such as detecting the variation of capacitance of the input pad.

As described above, it is possible to use all or some of the input pad as the input key constituting the keyboard input unit or the space input key. Thus, it is possible to dispose the keyboard input unit to be adjacent to the input pad, and so it is possible to decrease an area of the control board.

As described above, it is possible to recognize whether the hand manipulates the keyboard input unit or not by the use of the palm detecting section. Based on the recognition, it is possible to change the type of the input signal when the input pad is manipulated.

As described above, it is possible to recognize the manipulation when the output of the switch is switched or the output of the switch is not switched. Therefore, it is possible to perform diverse input manipulations by using the same input pad.

According to the embodiments, it is possible to perform the diverse input manipulations using the input pad by combining the capacitive input pad with the switch.

Furthermore, it is possible to dispose the keyboard input unit to be adjacent to the input pad in the control board. Therefore, it is possible to contribute to a small-scaled control board.

It is intended that the foregoing detailed description be regarded as illustrative rather than limiting, and that it be understood that the following claims, including all equivalents, are intended to define the scope of this invention.

What is claimed is:

1. An input device comprising:
an input pad operable to detect a contact with a manipulation body by the use of a variation in capacitance;
a data processor operable to analyze a contact position with the manipulation body on the input pad; and
a switch including an output operable to be switched when the input pad is pressed,
wherein the data processor is operable to generate different output signals when the output of the switch is switched and when the input pad detects the contact of the manipulation body without switching the output of the switch.

2. The input device according to claim 1, wherein the input pad is provided with a keyboard input unit having a plurality of input keys, and the data processor is operable to recognize that at least one of the input keys of the keyboard input unit is manipulated, and the data processor is operable to generate a key input signal when the output of the switch is switched.

3. The input device according to claim 2, wherein the data processor is operable to acquire a coordinate position where the manipulation body touches the input pad when the output of the switch is switched, operable to generate the key input signal when it is recognized that the contact position with the manipulation body is in a specific key input region, and operable to ignore the switching of the output of the switch or operable to acquire the coordinate position where the manipulation body touches the input pad so as to generate a pad input signal when the contact position with the manipulation body is not in the key input region.

4. The input device according to claim 3, wherein the data processor is operable to recognize that a space input key is manipulated and generates a space key input signal when the key input region is located in lines of the input keys of the keyboard input unit, operable to recognize that the output of the switch is switched, and operable to recognize detection of the manipulation body touching the key input region.

5. The input device according to claim 1, wherein the data processor is operable to acquire a coordinate position where the manipulation body touches the input pad and operable to generate a pad input signal when the output of the switch is not switched.

6. The input device according to claim 5, wherein the pad input signal is at least one of a signal for moving a pointer on a display screen and a signal for scrolling a displayed state on the display screen.

7. The input device according to claim 1,
wherein the input pad is provided with a keyboard input unit having a plurality of input keys,
wherein a palm detecting section operable to detect a position of a hand at the time of manipulating the keyboard is provided in the keyboard input unit, and
wherein the data processor is operable to generate a key input signal when the palm detecting section detects the hand and the output of the switch is switched, and the data processor is operable to acquire a coordinate position where the hand touches the input pad and operable to generate a pad input signal when the palm detecting section does not detect the hand.

8. The input device according to claim 7, wherein the data processor is operable to acquire the coordinate position where the hand touches the input pad when the palm detecting section detects the hand, and the data processor is operable to generate an input signal corresponding to a specific region when it is recognized on the basis of the coordinate position that the specific region is manipulated.

9. The input device according to claim 8, wherein the specific region is a mouse button input region and the input signal is a mouse button input signal.

10. The input device according to claim 1, wherein the data processor is operable to generate an input signal for moving a pointer on a display screen in accordance with a movement of the contact position where the manipulation body touches the input pad when the output of the switch is not switched, and the data processor is operable to generate a drag input signal when the output of the switch is switched.

11. The input device according to claim 1, wherein the data processor is operable to generate a scroll input signal for scrolling a displayed state in one direction on a display screen with a movement of the contact position where the manipulation body touches the input pad when the output of the switch is not switched, and the data processor is operable to generate a scroll input signal for scrolling the displayed state in the opposite direction on the display screen with the movement of the contact position where the manipulation body touches the input pad when the output of the switch is switched.

12. The input device according to claim 1, wherein the data processor is operable to ignore a detection state when the output of the switch is not switched and upon detection that the manipulation body touches a position of a pad input section, and the data processor is operable to generate a mouse button input signal when the output of the switch is switched and upon detection that the manipulation body touches the position of the pad input section.

13. The input device according to claim 1, wherein the data processor is operable to generate different input signals when the output of the switch is not switched and upon detection that the manipulation body touches a position of a pad input section and when the output of the switch is switched and upon detection that the manipulation body touches the position of the pad input section.
